(19) United States
(12) Patent Application Publication
(10) Pub. No.: US 2025/0217724 A1
(43) Pub. Date: Jul. 3, 2025

(54) COMPUTER-BASED SYSTEMS CONFIGURED TO EXECUTE AT LEAST ONE HIGH-POWER CONSUMING MODULE, SYSTEMS INCLUDING THE SAME, AND METHOD OF USING THE SAME

(71) Applicant: ChampionX Artificial Lift, Broken Arrow, OK (US)

(72) Inventors: Brian Hicks, Broken Arrow, OK (US); Ryan Rasmussen, Broken Arrow, OK (US); Charlie Fowler, Broken Arrow, OK (US)

(21) Appl. No.: 18/848,448

(22) PCT Filed: Mar. 14, 2023
(86) PCT No.: PCT/US2023/015162

§ 371 Date: Sep. 18, 2024

Related U.S. Application Data
(60) Provisional application No. 63/322,999, filed on Mar. 23, 2022.

(51) Int. Cl. G06Q 10/04; E21B 43/12; F04D 25/06; F04D 25/16; G06Q 30/0283; G06Q 50/06

(52) U.S. Cl. CPC G06Q 10/043; E21B 43/128; F04D 25/06; F04D 25/16; G06Q 30/0283; G06Q 50/06

(57) ABSTRACT

An example computer-based system includes at least one computer processor and non-transitory memory. The computer-based system also includes at least one high-power consuming module (e.g., program) configured to be executed on the computer processor or another computer processor. The computer-based system is configured to execute the high-power consuming module efficiently. For example, the computer-based system may include an energy-efficiency module that is configured to determine whether the high-power consuming module may be executed efficiently. The energy-efficiency module may permit or prevent execution of the high-power consuming module based on the determination, thereby improving the efficiency of the computer-based system.

### BACKGROUND

Certain computing processes consume large quantities of electrical power, which make such computing processes expensive and increases the carbon footprint of such computing process. An example of such computing processes is cryptocurrency mining and validation (e.g., Bitcoin mining and validation). As such, improved methods of performing such computing processes are being developed to make such computing processes cheaper and decrease the carbon footprint of such computing processes.

### SUMMARY

Embodiments are directed to computer-based systems configured to execute at least one high-power consuming module, systems including the same, and method of using the same. In an embodiment, a variable frequency drive. The variable frequency drive including a housing, at least one computer processor disposed in the housing, and non-transitory memory in communication with the at least one computer processor. The non-transitory memory is disposed in the housing. The variable frequency drive also including at least one transceiver disposed in the housing, a power input in or on the housing, a power output in or on the housing, and at least one high-power consuming module configured to be executed on at least one of the at least one computer processor or on at least one other computer processor. The at least one other computer processor is distinct from the at least one computer processor. The variable frequency driver further including an energy-efficiency module configured to be executed on at least one of the at least one computer processor or on the at least one other computer processor that is distinct from the at least one computer processor. The energy-efficiency module configured to determine whether the at least one high-power consuming module will or will not be efficiently executed on the at least one computer processor or on the at least one other computer processor. The energy-efficiency modules also configured to permit the at least one high-power consuming module to be executed on the at least one computer processor or on the at least one computer processor when the energy-efficiency module determines that doing so is desirable or prevent the at least one high-power consuming module from being executed on the at least one computer processor or on the at least one computer processor when the energy-efficiency module determines that doing so is desirable.

In an embodiment, an electrical submersible pumping system is disclosed. The electrical submersible pumping system including a power source and a variable frequency drive. The variable frequency drive including a housing, at least one computer processor disposed in the housing, and non-transitory memory in communication with the at least one computer processor. The non-transitory memory is disposed in the housing. The variable frequency drive also including at least one transceiver disposed in the housing, a power input in or on the housing, a power output in or on the housing, and at least one high-power consuming module configured to be executed on at least one of the at least one computer processor or on at least one other computer processor that is distinct from the at least one computer processor. The power input of the variable frequency driver is connected to the power source. The variable frequency drive is configured to be disposed on a surface. The electrical submersible pumping system also includes a pump configured to be disposed in a wellbore and an electric motor connected to the electrical power output of the variable frequency drive. The electric motor is configured to be disposed in the wellbore. The electric motor is connected to and configured to provide power to the pump. The submersible pumping system also includes a seal section configured to be disposed in a wellbore.

In an embodiment, a water pump system is disclosed. The water pump system includes one or more pumps in fluid commination with a water source and an outlet. The water pump system also includes one or more motors connected to or integrally formed with the one or more pumps and a variable frequency drive configured to at least partially control the one or more motors. The variable frequency drive including a housing, at least one computer processor disposed in the housing, and non-transitory memory in communication with the at least one computer processor. The non-transitory memory is disposed in the housing. The variable frequency drive also including at least one transceiver disposed in the housing, a power input in or on the housing, a power output in or on the housing, and at least one high-power consuming module configured to be executed on at least one of the at least one computer processor or on at least one other computer processor that is distinct from the at least one computer processor.

In an embodiment, a natural gas compressor is disclosed. The natural gas compressor includes one or more compressors in fluid commination with a natural gas source and an outlet. The natural gas compressor also includes one or more motors connected to or integrally formed with the one or more compressors and a variable frequency drive configured to at least partially control the one or more motors. The variable frequency drive including a housing, at least one computer processor disposed in the housing, and non-transitory memory in communication with the at least one computer processor. The non-transitory memory is disposed in the housing. The variable frequency drive also including at least one transceiver disposed in the housing, a power input in or on the housing, a power output in or on the housing, and at least one high-power consuming module configured to be executed on at least one of the at least one computer processor or on at least one other computer processor that is distinct from the at least one computer processor.

In an embodiment, a computer-based system is disclosed. The computer-based system includes at least one computer processor, non-transitory memory in communication with the at least one computer processor, at least one transceiver, at least one high-power consuming module executing on the at least one computer processor, and an energy-efficiency module. The energy-efficiency module is configured to determine whether the at least one high-power consuming module will or will not be efficiently executed on the at least one computer processor and selectively permit the at least one high-power consuming module to be executed.

In an embodiment, a method of using a computer-based system is disclosed. The computer-based system including, with an energy-efficiency module executed on at least one computer processor, determining whether at least one high-power consuming module will or will not be efficiently executed on the at least one computer processor, permitting the at least one high-power consuming module to be executed on the at least one computer processor when the energy-efficiency module determines that operating the at least one high-power consuming module is advantageous, and preventing the at least one high-power consuming module from being executed on the at least one computer processor when the energy-efficiency module determines that operating the at least one high-power consuming module is advantageous. The computer-based system includes memory in communication with the at least one computer processor and at least one transceiver.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a schematic illustration of a variable frequency driver, accordingly to an embodiment.

FIG. 2 is a schematic illustration of a variable frequency driver, accordingly to an embodiment.

FIG. 3 is a schematic illustration of an electrical submersible pump system, according to an embodiment.

FIG. 4 is a schematic illustration of a water pump system, according to an embodiment.

FIG. 5 is a schematic illustration of a natural gas compressor system, according to an embodiment.

### DETAILED DESCRIPTION

Embodiments are directed to computer-based systems configured to execute at least one high-power consuming module, systems including the same, and method of using the same. An example computer-based system includes at least one computer processor and non-transitory memory. The computer-based system also includes at least one high-power consuming module (e.g., program) configured to be executed on the computer processor or another computer processor. The computer-based system is configured to execute the high-power consuming module efficiently. For example, the computer-based system may include an energy-efficiency module that is configured to determine whether the high-power consuming module may be executed efficiently. The energy-efficiency module may permit or prevent execution of the high-power consuming module based on the determination, thereby improving the efficiency of the computer-based system.

An example of a high-power consuming module is a cryptocurrency module that is configured to mine cryptocurrency. As used herein, mine and similar terms (e.g., mining) refers to the process by which new cryptocurrency is entered into circulation (e.g., by solving complex computational math problems), confirming new transactions of cryptocurrency, monitoring cryptocurrency, or validating cryptocurrency. The cryptocurrency module may be configured to mine any cryptocurrency, such as Bitcoin, Ethereum, or Dogecoin. Mining cryptocurrency involves complex algorithms and processes that need to be performed quickly. As such, mining cryptocurrency requires large computers which, in turn, requires large amounts of electrical power. As mining cryptocurrency becomes more complex, larger computers and more electrical power are required to mine cryptocurrency. As of September 2021, the amount of electrical power used in the mining and validation of cryptocurrency is about 0.5% of all the electrical power generated world-wide and exceeds the electrical power usage of some countries, such as Denmark, Chile, and Finland. Jon Huang et al., Bitcoin Uses More Electricity Than Many Countries. How Is That Possible, The New York Times (Sep. 3, 2021). Further, the electrical power used by cryptocurrency has increased tenfold in five years prior to September 2021, indicating the significant amounts of electrical power will be needed in the future to mine cryptocurrency. Id.

Although the high-power consuming modules disclosed herein are primarily disclosed as being a cryptocurrency module, it is noted that the high-power consuming modules disclosed herein may include other, non-cryptocurrency modules. For example, the high-power consuming modules disclosed herein may include modules configured to execute complex simulations (e.g., astrophysics simulations), the Search for Extraterrestrial Intelligence System operated through the Berkeley Open Infrastructure for Network Computing, weather predicting modules, artificial intelligence, or other suitable high-power consuming computing process.

Conventional computer-based systems that execute the high-power consuming modules, especially cryptocurrency modules, are often performed on computer-based systems that are specially configured to execute such high-power consuming modules. Such specially configured conventional computer-based systems require a continuous supply of large amounts of electrical power to operate and make the operation of such specially configured computer-based systems cost prohibitive. The continuous use of the large quantities of electrical power by such specially configured conventional computing systems makes the operation of such computer-based systems inefficient by increasing the cost of operating and increasing the carbon footprint of such conventional systems.

The computer-based systems disclosed herein are an improvement over such conventional computer-based systems. For example, the computer-based systems disclosed herein do not require a continuous supply of large amounts of electrical power to operate. Instead, the computer-based systems disclosed herein may include an energy-efficiency module that may permit the high-power consuming module to be executed when the high-power consuming module may be efficiently executed. For instance, the energy-efficiency module may only permit the execution of the high-power consuming module when there is excess electrical power available or cost-effective electrical power available. Since excess electrical power would be otherwise wasted, using such excess electrical power to execute the high-power consuming module decreases the carbon footprint of the high-power consuming module. The energy-efficiency module may also permit the execution of the high-power consuming module when it is cost-effective to do so (e.g., when electrical power is cheap or free). This limits the overall quantity and/or cost of electrical power that is used to operate the computer-based systems disclosed herein, rather than continuously execute the high-power consuming module. Further, it is often cost-effective to execute the high-power consuming module when there is excess electrical power and/or renewable energy readily available. As such, executing the high-power consuming module when it is cost effective is also, typically, environmental beneficial. Further, the energy-efficiency module also allows the high-power consuming module to be executed on an already-existing computer-based systems (e.g., variable frequency drives) rather than computer-based systems that are specially configured to execute the high-power consuming module. Using the already-existing computer-based systems makes execution of the high-power consuming module more environmentally friendly. For instance, when the high-power consuming module is executed on the already-existing computer-based system, only one computer-based system needs to be disposed of at the end of the lifetime thereof, which minimizes the volume of waste and, since computer-based systems may include environmentally hazardous waste, simplifies the disposal thereof. However, if the high-power consuming module is executed on a specially configured computer-based system, two computer-based systems would exist, namely the already-existing computer-based system and the specially configured computer-based system, thereby increasing the waste generated and the environmentally hazardous waste generated at the end of the lives thereof. Further, executing the high-power consuming module on the already-existing computer-based system maximizes the utility of the already-existing computer-based system and may make the already-existing computer-based system more energy efficient (e.g., spreads the electrical power used to execute background application over more computing operations).

In a particular embodiment, an example of an already-existing computer-based system includes a variable frequency drive (“VFD”). The VFD is also known as variable speed drive, adjustable speed drive, and adjustable frequency drive. VFDs are configured to receive electrical power and output electrical power that is different from the electrical power received thereby (e.g., change at least one of the voltage, current, frequency, AC electrical power to DC electrical power, or DC electrical power to AC electrical power). The power outputted from the VFD is often provided to electric motors. The VFD includes an electrical power control module that, when executed on a computer processor of the VFD, controls the characteristics of the power outputted by the VFD. Executing the high-power consuming module on the VFD is an improvement over conventional computer-based systems for a variety of reasons. In an example, VFDs are plentiful and are often connected to computer networks. Further, VFDs are often manufactured to handle large computing processes which allows the VFDs to handle the most demanding processes of the electrical power control module. However, the electrical power control module rarely requires the VFDs to perform the most demanding processes. As such, the VFDs often have excess computing power that may handle executing the high-power consuming module. The plentiful supply of VFDs and the facts that VFDs are often connected to networks and often have excess computing power makes VFDs an exceptionally good choice for executing the high-power consuming modules individually or, through parallel computing (e.g., distributed computing). Executing the high-power consuming module on the VFDs through parallel computing may also allow the VFDs to execute the high-power consuming modules in an efficient manner when the VFDs include an energy-efficiency module. For example, the energy-efficiency module may only permit VFDs that are operating in locations with excess electrical power and/or in locations having low electrical cost. In other words, the plentiful supply of VFDs allows for “cherry picking” VFDs that may execute the high-power consuming module in a cost-effective and/or environmentally friendly manner.

VFDs that may execute the high-power consuming modules may be used in a variety of applications, such as in electric cars, industrial water pumps, and natural gas compressors. However, one particular application of VFDs that may execute the high-power consuming modules includes VFDs used in oil and gas exploration, such as VFDs used in downhole drilling systems, electrical submersible pump (“ESP”) systems, or other artificial lift systems. For example, VFDs used in oil and gas exploration are often plentiful. The VFDs used in oil and gas exploration may have large computing power. However, the VFDs used in oil and gas exploration often do not use all of their large computing power due to downtime and the power control modules thereof often do not need to use all of the large computing power. The plentiful supply and excess computing power of the VFDs used in oil and gas exploration makes such VFDs an excellent computer-based system to execute the high-power consuming modules in a cost effective and/or environmentally efficient manner. Further, the location of the VFDs used in oil and gas exploration also improves the ability of such VFDs to execute the high-power consuming modules in an efficient manner. For example, the VFDs used in oil and gas exploration are often located close to power generating sources, particular renewable energy sources, since such VFDs are located in rural areas. The proximity of the VFDs used in oil and gas exploration to the power generating sources decreases the loss of electrical energy due to the resistivity of the electrical wires thereby making the VFDs more energy efficient than many other computer-based systems.

It is noted that the computer-based systems disclosed herein may include computer-based systems other than VFDs and/or VFDs used in applications other than oil and gas exploration. For example, the computer-based systems disclosed herein may include a home computer, a gaming computer, a server, etc. However, for brevity, the computer-based systems disclosed herein are often disclosed as being VFDs and/or VFDs used in oil and gas exploration. However, it is noted that the principles discussed with regards to the VFDs and/or VFDs used in oil and gas exploration apply to other computer-based systems since the other computer-based systems often include a computer processor that may execute the energy-efficiency module and/or the high-power consuming module, memory, a transceiver, and a user interface.

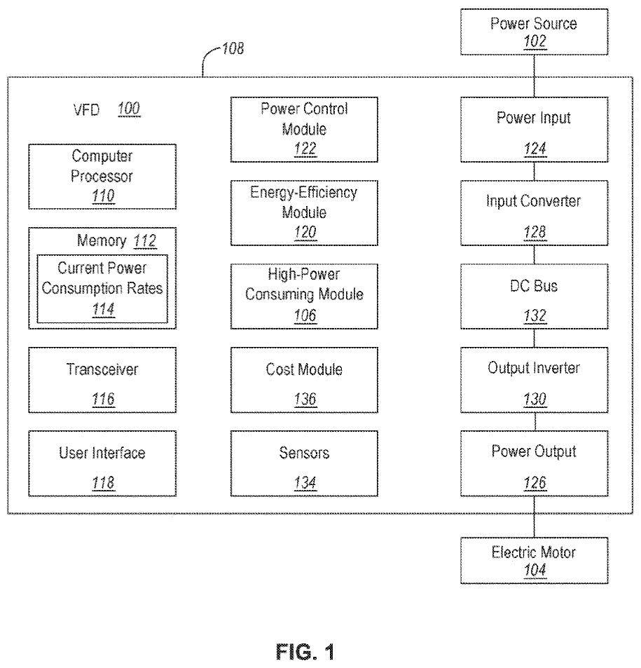

FIG. 1 is a schematic illustration of a VFD 100, accordingly to an embodiment. The VFD 100 is configured to receive electrical power from a power source 102 and output electrical power, for example, to an electric motor 104. The VFD 100 is configured to modify the electrical power received from the power source 102 such that the power outputted therefrom may be different from the electrical power received from the power source 102. The VFD 100 is also configured to execute at least one high-power consuming module 106 in an efficient manner (e.g., a cost effective and/or environmentally beneficial manner).

The VFD 100 includes a housing 108. The housing 108 is configured to have one or more components of the VFD 100 disposed therein or thereon. Often, the VFD 100 is located in an outdoor environment or other hazardous environment that may damage one or more components of the VFD 100. As such, the housing 108 may be configured to isolate at least some of the components of the VFD 100 from an environment. For example, the housing 108 may be at least water resistant (e.g., at least substantially waterproof) and/or dust resistant to protect the computer processor 110, the memory 112, and other sensitive components of the VFD 100 from water (e.g., rain) and/or dust.

The VFD 100 includes at least one computer processor 110. The computer processor 110 is configured to execute one or more operational instructions, one or more modules, etc. The computer processor 110 may include any suitable processor. In an example, the computer processor 110 includes a central processing unit (“CPU”) since the CPU may efficiently execute operational instructions and modules commonly found in conventional VFDs. In an example, the computer processor 110 includes a graphics processing unit (“GPU”) since GPUs may be more effective at executing some high-power consuming modules, such as a cryptocurrency module. In an example, the computer processor 110 includes at least one application specific integrated circuit (“ASIC”) computer since ASIC computer may be more effective at executing some high-power consuming modules. In an example, the computer processor 110 includes at least one CPU and at least one GPU.

The VFD 100 includes memory 112. The memory 112 may include any suitable transitory or non-transitory memory, such as random access memory, dynamic random access memory, hard disk drive(s), solid state drive(s), any other suitable memory storage medium, or combinations thereof. The memory 112 may store one or more operational instructions, data (e.g., current power consumption rates 114), or modules. The memory 112 may be communicably connected to the computer processor 110, for example, via a bus (not shown). The computer processor 110 may be configured to execute the operational instructions and the modules stored in the memory 112, for example, using the data that is also stored in the memory 112.

The VFD 100 includes at least one transceiver 116. The transceiver 116 is configured to connect the VFD 100 to a network, such as a local area network, a wide area network, or any other suitable network. As such, the transceiver 116 can receive and transmit data between the VFD 100 and the network and/or between the VFD 100 and another computer-based system. The transceiver 116 may include any suitable transceiver, such as a Bluetooth transceiver, a cellular network transceiver, a modem, a router, radio frequency transceiver, another suitable transceiver, or combinations thereof.

In an embodiment, the transceiver 116 is configured to be connected to a wide area network. In such an embodiment, the transceiver 116 may receive and transmit data over distances greater than 500 m. In an example, the transceiver 116 may be able to communicate with a local power provider to receive the current power consumption rates 114. In an example, the transceiver 116 may be able to communicate with at least one other computer-based system, thereby allowing the VFD 100 to participate in parallel computing with the other computer-based system. In an example, the transceiver 116 may be configured to communicate with a remote user, thereby allowing the remote user to access information about the VFD 100 and/or change the settings of the VFD 100 (e.g., change the operating parameters of the electric motor 104, execute or stop executing the high-power consuming module 106, etc.).

The VFD 100 may include a user interface 118. The user interface 118 allows the VFD 100 to communicate with a user of the VFD 100. For example, the user interface 118 may include a display, an input (e.g., mouse, keyboard, etc.), and a graphics user interface. In a particular example, the user interface 118 may include a touchscreen. In an embodiment, the user interface 118 is configured to display information to the user, such as the status of at least one of the VFD 100, the electric motor 104, the high-power consuming module 106, the current power consumption rates 114, or any other suitable information. In an embodiment, the user interface 118 allows the user to input information into the VFD 100, such as the threshold values at which the energy-efficiency module 120 permits the high-power consuming module 106 to be executed, operational parameters for using the electric motor 104, etc.

As previously discussed, the VFD 100 includes one or more modules. The modules may be software and/or hardware that is executable by a computer processor 110. The modules may include operational instructions and data. The modules may be executed by the computer processor 110. The modules may be stored on the memory 112 or may be distinct from the memory 112 (e.g., the modules are distinct electronic circuits).

The one or more modules of the VFD 100 may include a power control module 122. The power control module 122 may be the primary module of the VFD 100. That is, the power control module 122 may be the module of the VFD 100 that is configured to be executed and the high-power consuming module 106 and the energy-efficiency module 120 may only be executed by the VFD 100 when the power control module 122 is not being executed or there is excess computing power left over while executing the power control module 122.

The power control module 122 is configured to control the electrical power that is outputted from the VFD 100. For example, as previously discussed, the VFD 100 receives electrical power from the power source 102. The VFD 100 modifies (e.g., transforms, changes the wavefor/amplitude/frequency/shape of alternating voltage/current, combinations thereof, or any other modification as known in the art) the electrical power received thereby such that the power outputted thereby is different than the electrical power received by the VFD 100. The power control module 122 controls the one or more components of the VFD 100 that modifies the electrical power. In other words, the power control module 122 controls how the VFD 100 delivers the electrical power. In a particular embodiment, the power provided by the VFD 100 is configured to control the speed of electric motor 104. For example, the speed of the electric motor 104 is controlled, in part, based on the frequency of the electrical current that is provided to the electric motor 104 from the VFD 100. Since the power control module 122 controls how the electrical power is supplied by the VFD 100, the power control module 122 effectively controls at least the speed of the electric motor 104.

The VFD 100 includes a power input 124 that is configured to receive electrical power from the power source 102 and a power output 126 configured to output electrical power to one or more devices, such as to the electric motor 104. The VFD 100 also includes one or more components between the power input 124 and the power output 126 that are at least partially controlled by the power control module 122. The one or more components are configured to modify the electrical power such that the electrical power received at the power input 124 is different than the power outputted from the power output 126. In other words, the VFD 100 includes one or more components that changes the electrical power from one form to another, such as at least one of AC power to DC power, DC power to AC power, changes the voltage, changes the current, or changes the frequency. In an embodiment, as illustrated, that one or more components of the VFD 100 that are configured to transform or modify the electrical power includes an input converter 128 connected to the power input 124, an output inverter 130 connected to the power output 126, and a DC bus 132 between and connected to the input converter 128 and the output inverter 130.

In an embodiment, the electrical power received by the power input 124 may be AC electrical power. In such an embodiment, the input converter 128 is configured to convert or transform the AC voltage and current into DC voltage and current. The input converter 128 may include a three-phase full bridge rectifier or a multipulse converter. The DC bus 132 may receive the DC power from the input converter 128. The DC bus 132 may comprise a dampened low-pass filter that smooths the DC power from the input converter 128. The DC power provided from the DC bus 132 may then be received by the output inverter 130. The output inverter 130 converts or transforms the DC electrical power into AC electrical power. In an example, the output inverter 130 is a voltage source inverter that is configured to control the voltage waveform supplied therefrom and the current supplied therefrom depends on the load connected to the output inverter 130. The voltage source inverter may include a variable voltage inverter (e.g., six step inverter), pulse-width-modulated inverter, or a constant voltage inverter. In an example, the output inverter 130 may comprise a current source inverter that is configured to control the current waveform output and the voltage output depends on the load connected to the output inverter 130. The power control module 122 controls the operation of at least one of the input converter 128 (e.g., how the input converter 128 changes the AC power to DC power), the DC bus 132 (e.g., how the DC bus 132 smooths the AC power), or the output inverter 130 (e.g., how the output inverter 130 changes the DC power to AC power).

The VFD 100 may comprise one or more sensors 134 configured to sense one or more signals, conditions, and/or characteristics. The one or more sensors 134 may be disposed in the housing 108 (as shown), disposed on the housing 108, or spaced from the housing 108 (e.g., on or near the electric motor 104). The one or more sensors 134 may sense one or more characteristics of the VFD 100, one or more characteristics of the electric motor 104, one or more characteristics of the environment that the VFD 100 is disposed (e.g., weather), or one or more characteristics of the environment that the electric motor 104 is disposed. For example, the one or more sensors 134 may include an acoustic sensor, a sound sensor, a vibration sensor, a flow meter, a defect detector, a temperature sensor configured to sense the temperature of an environment, a temperature sensor configured to sense the temperature of the VFD 100 or the electric motor 104, a speed detector, light sensor, oil level sensor, oil pressure sensor, torque sensor, chemical sensor, a current sensor configured to detect the current of electrical power received into or outputted from the VFD 100, a current sensor configured to detect current received into or at any location in the electric motor 104, a frequency sensor configured to detect the frequency of electrical power received into or outputted from the VFD 100, a frequency sensor configured to detect frequency of a current received into or at any location in the electric motor 104, a voltage sensor configured to detect the voltage of electrical power received into or outputted from the VFD 100, a voltage sensor configured to detect voltage received into or at any location in the electric motor 104, a multimeter, a flow sensor, an accelerometer, a pressure sensor, or any other suitable sensor.

The power control module 122 may control the electrical power outputted from the VFD 100 based on the one or more characteristics sensed by the one or more sensors 134. In an example, the power control module 122 may change the frequency of the electrical power output to the electric motor 104 if the speed of the electric motor 104 is different from the desired speed thereof. In an example, the power control module 122 may use (e.g., control or sense) the at least one of the current, the voltage, or the frequency of the electrical power received at the power input 124 and/or output from the power output 126 to determine how the VFD 100 modifies the electrical power received thereby.

The VFD 100 may have relatively significant amount of computing power. For example, VFD 100 may require significant computing power to execute the power control module 122 in certain situations, such as during start up and shut down of the electric motor 104 or during non-typical operation of the electric motor 104. The power control module 122 may not use all of the computing power of the VFD 100 at all times and, as such, the VFD 100 may have excess computing power available at certain times. The VFD 100 includes at least one high-power consuming module 106. The high-power consuming module 106 may use at least some of the excess computing power of the VFD 100. As such, the high-power consuming module 106 may allow for greater utility of the VFD 100 by using more of the computing power of the VFD 100 (i.e., greater “bang for buck”). Further, executing the high-power consuming module 106 on the VFD 100 allows the high-power consuming module 106 to be executed without needing a new computing system, without supplying electrical power to a new location, and without the need to supply electrical power to run the background applications of the new computing device.

The high-power consuming module 106 may include any suitable module. In an embodiment, the high-power consuming module 106 may include at least one cryptocurrency module configured to mine cryptocurrency. The cryptocurrency module may be configured to mine Bitcoin, Litecoin, Ethereum, Bitcoin Cash, Ethereum Cash, Zcash, Stellar Lumen, Bitcoin Satoshi's Vision, Chainlink, combinations thereof, or any other one or more cryptocurrencies. The cryptocurrency module may include modules to mine two or more cryptocurrencies, such as a cryptocurrency module configured to mine Bitcoin and a separate cryptocurrency module configured to mine Litecoin. In an example, the cryptocurrency module may only be configured to perform a portion of the mining process while the other portion(s) of the mining process may be performed by another computer-based system (e.g., another VFD) through parallel computing. In such an example, the VFD 100 may have software or components (e.g., a CPU or GPU) that may execute certain portions of the mining process more or less efficiency than another computer-based system and, as such, the cryptocurrency module may only include the certain portions of the cryptocurrency module that the computer-based system may perform efficiently. As previously discussed, the high-power consuming module 106 may include non-cryptocurrency modules, such as simulation modules.

The VFD 100 may require a relatively large amount of electrical power to execute the high-power consuming module 106. As such, the VFD 100 may include an energy-efficiency module 120. The energy-efficiency module 120 is configured to determine when the high-power consuming module 106 may be executed by the VFD 100 efficiently. When the energy-efficiency module 120 determines that the high-power consuming module 106 may be executed efficiency, the energy-efficiency module 120 may permit the high-power consuming module 106 to be executed by the computer processor 110. When the energy-efficiency module 120 determines that the high-power consuming module 106 may not be executed efficiently, the energy-efficiency module 120 may limit or prevent (e.g., restrict or stop) the high-power consuming module 106 from being executed by the computer processor 110. As such, the energy-efficiency module 120 improves the efficiency of the VFD 100 and the execution of the high-power consuming module 106 by only permitting efficient execution of the high-power consuming module 106.

In an embodiment, the energy-efficiency module 120 determines whether the high-power consuming module 106 may be efficiently executed by the VFD 100 at least partially based on the amount of electrical power supplied on-site (e.g., the site that includes the VFD 100). For example, a certain amount of electrical power may be provided on-site to power the VFD 100 and, optionally, the electric motor 104 or other on-site components. The certain amount of electrical power may be provided from an on-site generator, on-site renewable energy, or another power source. Any of the power that is not used on-site may be wasted, such as when there is no on-site energy storage device to receive the excess electrical power or the energy storage device is full. When the excess electrical power is present, the energy-efficiency module 120 may permit the high-power consuming module 106 to be executed by the VFD 100 since the execution of the high-power consuming module 106 uses electrical power that would otherwise be wasted. In other words, the energy-efficiency module 120 allows the electrical power provided on-site to be used more efficiently (e.g., closer to all of the electrical power provided on-site to be used). The energy-efficiency module 120 may be configured to detect when there is excess electrical power. In an example, the one or more sensors 134 may detect the electrical power provided on-site and may detect the electrical power used by the VFD 100 and the other on-site components. In such an example, the energy-efficiency module 120 may compare the detected electrical power provided and used to determine the excess electrical power. In an example, the energy-efficiency module 120 may estimate the electrical power being provided and/or consumed. In an example, the one or more sensors 134 may detect one or more characteristics of the environment (e.g., light, wind speed, etc.) and the energy-efficiency module 120 may estimate the amount of power provided on-site by renewable energy at least partially based on one or more sensed characteristics of the environment. In an embodiment, the energy-efficiency module 120 may only permit the high-power consuming module 106 to be executed when electrical power provided on-site is in excess of a threshold value. In an example, the threshold value may be greater than the electrical power needed to execute all of the high-power consuming module 106 which allows the high-power consuming module 106 to be executed in a carbon-neutral manner. In an example, the threshold value may be less than the electrical power needed to execute all of the high-power consuming module 106 (e.g., the threshold value is greater than 10%, greater than 25%, greater than 50%, or greater than 75%) of the power needed to execute the high-power consuming module 106, thereby decreasing the carbon footprint of the high-power consuming module 106.

In an embodiment, the energy-efficiency module 120 determines whether the high-power consuming module 106 may be efficiently executed by the VFD 100 at least partially based on the availability of excess electrical power in a region. For example, regional power providers often generate excess electrical power for a region for several reasons, such as to accommodate surges in power usage. Using the excess electrical power provided to the region to execute the high-power consuming module 106 decreases the carbon footprint of using the high-power consuming module 106 since the excess power may be otherwise wasted. The energy-efficiency module 120 may use one or more different methods for determining whether there is excess electrical power in a region. In an embodiment, the energy provider for the region may provide data about when there is excess electrical power provided in a region. In such an embodiment, the transceiver 116 may be configured to receive the data from the energy providers. The energy-efficiency module 120 may analyze or measure the data to determine whether there is excess power in the region. This data may be periodically received by the transceiver 116 so the energy-efficiency module 120 may determine whether to permit or prevent the high-power consuming module 106 from being executed when the excess electrical power increases or decreases, respectively, over time. It is noted that not all energy providers provide data regarding the excess electrical power in a region, so this method may only be available in certain regions. In an embodiment, the energy provider does not provide data about when there is excess electrical power provided in a region. In such an embodiment, the energy-efficiency module 120 may use historical data, the one or more sensors 134, or combinations thereof to determine when there is excess electrical power in the region. For example, the historical data may be used to determine which time of day energy in the region is being used less which, in turn, may indicate when there is excess electrical energy in the region since power providers often provide electrical power at or near peak levels. The one or more sensors 134 may also be used to analyze or measure the environment (e.g., light intensity and wind speed) to determine when nearby renewable energy sources are likely to be generating greater than or below average electrical power. The energy-efficiency module 120 may use the historical data or the one or more sensors 134 to determine whether there is likely to be excess electrical power provided to the region. In an embodiment, the energy-efficiency module 120 may only permit the high-power consuming module 106 to be executed when the electrical power in the region is above a threshold value. In an example, the threshold value may be greater than the electrical power needed to execute all of the high-power consuming module 106 which allows the high-power consuming module 106 to be executed in a carbon-neutral manner. In an example, the threshold value may be less than the electrical power needed to execute all of the high-power consuming module 106 (e.g., the threshold value is greater than 10%, greater than 25%, greater than 50%, or greater than 75%) of the power needed to execute the high-power consuming module 106, thereby decreasing the carbon footprint of the high-power consuming module 106.

In an embodiment, the energy-efficiency module 120 determines whether the high-power consuming module 106 may be efficiently executed by the VFD 100 at least partially based on the current price of electrical power. For example, some energy providers vary the price of electrical power and publish the current price of electrical power. The transceiver 116 may receive the current price of electrical power. The current price of electrical power may be stored in the VFD 100, such as on the memory 112, as the current power consumption rates 114. The energy-efficiency module 120 may measure and/or analyze the current power consumption rates 114 to determine when the high-power consuming module 106 may be executed. In an embodiment, the energy-efficiency module 120 may permit the high-power consuming module 106 to be executed when the price of consuming the electrical power is below a threshold value. The threshold value may be selected to be less than the value derived from executing the high-power consuming module 106 or based on some other criteria. Permitting the high-power consuming module 106 to be executed when the price of electrical power is less than the threshold may make executing the high-power consuming module 106 more economically efficient. In an embodiment, the price of electrical power may indicate the availability of excess electrical power and the availability of electrical power for a period of time going forward. For instance, the price of electrical power may decrease when there is excess electrical power in a region or there is expected to be excess electrical power shortly. As such, the energy-efficiency module 120 may use the current power consumption rates 114 to determine or predict when there is or may be excess electrical power available or to confirm that there is excess electrical power available. The price of electrical power may also indicate the availability of electrical energy generated by renewable energy since a decrease in the price of electrical energy may coincide with increased electrical power generated by renewable energy. Thus, the energy-efficiency module 120 may use the current power consumption rates 114 to determine when electrical power is generated in an environmentally beneficial manner.

In an embodiment, the energy-efficiency module 120 may use at least one weather-related variables to determine whether the high-power consuming module 106 may be efficiently executed by the VFD 100. In an example, the VFD 100 may determine or measure at least one weather-related variable using the one or more sensors 134 or using the transceiver 116 receiving information containing or related to the weather related variables (e.g., current temperature, forecast temperature, presence of clouds, forecast of clouds, current precipitation, forecast precipitation, current wind speed/direction, predicted wind speed/direction, combinations thereof, etc.) from another source. The one or more weather related variables may indicate when there is excess electrical power or when excess electrical power may quickly dissipate. For instance, clear, sunny weather may indicate favorable conditions for solar power generation and may be used to predict when excess electrical power from renewable energy may be present in a region. In another instance, severe weather events may indicate when a sudden decrease in excess electrical power due to individuals heating their homes and/or transmission line damage. As such, the energy-efficiency module 120 may use weather-related variables to determine when the high-power consuming module 106 may be used efficiently.

In an embodiment, the energy-efficiency module 120 may determine whether the high-power consuming module 106 may be efficiently executed by the VFD 100 at least partially based on the computing power available of the VFD 100. In an example, the energy-efficiency module 120 may only permit the high-power consuming module 106 to be executed when the available computing power of the VFD 100 is above a threshold value. The threshold value may be selected to be sufficiently large that the high-power consuming module 106 may be efficiently run and variations in the other demands of the VFD 100 (e.g., increased computing power needed to execute the power control module t22) is unlikely to affect the execution of the high-power consuming module 106.

In an embodiment, the energy-efficiency module 120 may determine whether the high-power consuming module 106 may be efficiently executed by the VFD 100 at least partially based on the availability of excess computing power available on linked computer-based systems. As previously discussed, the VFD 100 may be configured to execute the high-power consuming module 106 using parallel computing. In some examples, there may need to be sufficient collective computing power from at least some of the linked computing systems to make executing the high-power consuming module 106 through parallel computing efficient or worthwhile. As such, the energy-efficiency module 120 may limit or prevent execution of the high-power consuming module 106 when the VFD 100 has sufficient excess computing power but the other linked computer systems collectively do not have sufficient computing power to make execution of the high-power consuming module 106 worthwhile.

In an embodiment, when the high-power consuming module 106 is a cryptocurrency module, the energy-efficiency module 120 determines whether the high-power consuming module 106 may be efficiently executed by the VFD 100 at least partially based on the current price of cryptocurrency. The transceiver 116 may receive the current price of the cryptocurrency. The energy-efficiency module 120 may analyze, measure, or determine the current price of the cryptocurrency, including whether the price of the cryptocurrency is generally increasing or decreasing, to determine whether the high-power consuming module 106 may be efficiently executed by the VFD 100. In an example, the energy-efficiency module 120 may only permit the high-power consuming module 106 to be executed when the price of the cryptocurrency is above a predetermined threshold value. In an example, the energy-efficiency module 120 may only permit the high-power consuming module 106 to be executed when the price of the cryptocurrency is greater than an expected cost of mining the cryptocurrency. In such an example, the energy-efficiency module 120 may estimate the power required to mine the cryptocurrency and may measure or estimate the current price of electrical power.

The VFD 100 may include additional modules other than the high-power consuming module 106, the energy-efficiency module 120, and the power control module 122. In an embodiment, the VFD 100 may include a cost module 136. The cost module 136 may be configured to determine, predict, or at least estimate at least one of the cost of executing the high-power consuming module 106 (e.g., using the cost of current power consumption rates 114 and the cost of electrical power used for executing the high-power consuming module 106) or the value obtained by executing the high-power consuming module 106 (e.g., the cryptocurrency value obtained mining and/or validating the cryptocurrency). The cost module 136 may then use the information determined or estimated thereby to distribute costs of executing the high-power consuming module 106. For example, a first party may be responsible for paying for the electrical energy used by the VFD 100 (e.g., a leasee of the VFD 100) while a second party may obtain value for executing the high-power consuming module 106 on the VFD 100 (e.g., an owner of the VFD 100). In such an example, the cost module 136 may request that the second party provide value to the first party (e.g., transferring funds or providing rebates) to help offset the costs resulting from the electrical power consumed by the high-power consuming module 106.

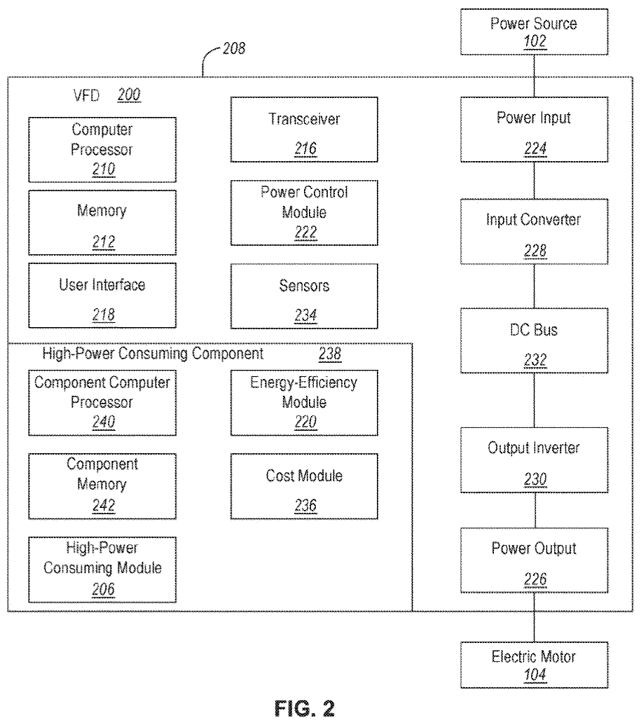

FIG. 2 is a schematic illustration of a VFD 200, accordingly to an embodiment. Except as otherwise disclosed herein, the VFD 200 is the same or substantially similar to the VFD 100 illustrated in FIG. 1. For example, the VFD 200 may include at least one computer processor 210, memory 212, a transceiver 216, a user interface 218, and one or more sensors 234. The VFD 200 may also include a power control module 222 configure to transform and/or modify electrical power received from a power source 102 at a power input 224 that is outputted from the power output 226, for example, to an electric motor 104. For instance, the power control module 222 may transform and/or modify the electrical power using an input converter 228, a DC bus 232, and an output inverter 230.

The VFD 200 includes a housing 208. The housing 208 may be larger than needed to house the components of the VFD 200. For example, the housing 208 may form a kiosk or standing desk since, in the field, there may not be a structure to house or support the VFD 200. The VFD 200 may include a high-power consuming component 238 disposed in the otherwise vacant space of the housing 208. Disposing the high-power consuming component 238 in the housing 208 allows the housing 208 to protect the high-power consuming component 238.

The high-power consuming component 238 may be a computer-based system that is configured to execute a high-power consuming module 206. For example, the high-power consuming component 238 may include at least one component computer processor 240 (e.g., GPU) that is distinct from the computer processor 210 and component memory 242 (e.g., non-transient memory) that is distinct from the memory 212. The high-power consuming component 238 may also include the high power consuming module 206, an energy-efficiency module 220, and a cost module 236. The high-power consuming module 206, the energy-efficiency module 220, and the cost module 236 may be the same as or substantially similar to any of the high-power consuming modules, the energy-efficiency modules, and cost modules disclosed herein. It is noted that at least one of the high-power consuming module 206, the energy-efficiency module 220, or the cost module 236 may be disposed outside of the high-power consuming component 238 and, instead, may be executed by the computer processor 210. The high-power consuming component 238 may include other components (not shown), such as a component transceiver, a component power input, etc.

The high-power consuming component 238 may increase the computing power of the VFD 200. In particular, the high-power consuming component 238 may substantially provide excess computing power to execute the high-power consuming module 206. For example, the high-power consuming component 238 may allow the high-power consuming module 206 to be executed thereon regardless of whether the computer processor 210 has excess computing power. In other words, the energy-efficiency module 220 may permit the high-power consuming module 206 to be executed based on the availability of electrical power alone (e.g., instead of optionally relying on the excess computing power of the computer processor 210).

In an embodiment, the high-power consuming component 238 is communicably coupled to the VFD 200. In an example, the high-power consuming component 238 may receive data communicated to the transceiver 216, data stored on the memory 212, and/or data sensed or measured by the one or more sensors 234. In an example, the high-power consuming component 238 may communicate with the computer processor 210 such that the high-power consuming module 206 is also executed on the computer processor 210 when the computer processor 210 has excess computing power in addition to being executed on the at least one component computer processor 240. In an example, the high-power consuming component 238 may communicate with the computer processor 210 such that the power control module 222 or another module may be executed on the at least one component computer processor 240 when excess computing power is needed.

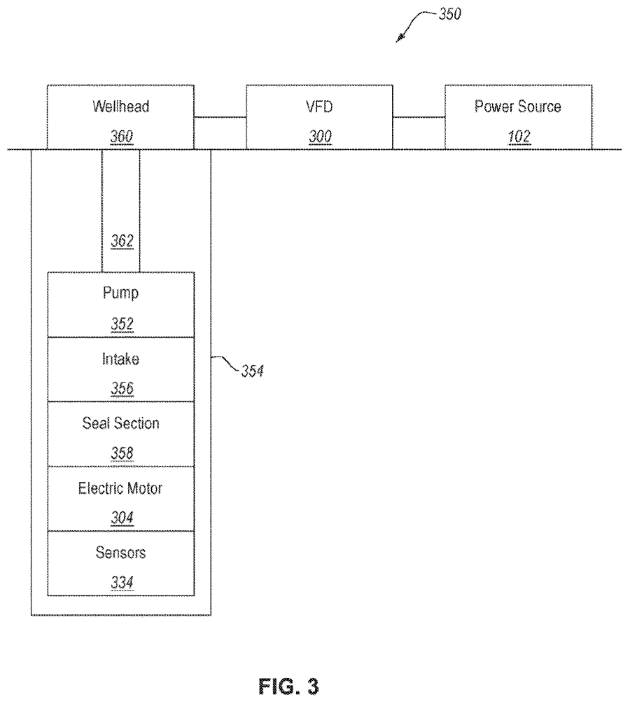

As previously discussed, the VFDs disclosed herein may be used in a system, such as an electrical submersible pump (“ESP”) system. The ESP system is an artificial lift system configured to remove well fluids from wellbores. The well fluids removed from the wellbores by the ESP system may include liquid petroleum products, disposal or injection fluids, fluids containing free gas, some solids or contaminates, or gases (e.g., carbon dioxide or hydrogen sulfide). FIG. 3 is a schematic illustration of an ESP system 350, according to an embodiment. The ESP system 350 includes a VFD 300 that is the same or substantially similar to any of the VFDs disclosed herein. The VFD 300 is connected to a power source 102. The ESP system 350 also includes an electric motor 304 connected to the VFD 300 and a pump 352 connected to the electric motor 304. The electric motor 304 is configured to provide power to the pump 352 such that the well liquids may be removed from the wellbore 354.

When used in the ESP system 350, the VFD 300 is configured to control the electric motor 304. Using the VFD 300 in an ESP system 350 may provide an advantage, such as at least one of increasing the application range of the ESP system 350, improving the efficiency of the ESP system 350 (e.g., improve the efficiency of the downhole components of the ESP system 350), increasing the production of the wellbore 354, isolating at least some of the components of the ESP system 350 from the power source 102, reducing stresses generated in the ESP system 350 during startup, or making maintenance of the ESP system 350 easier.

The electric motor 304 may include any electric motor suitable for downhole operations. In an embodiment, the electric motor 304 may include a substantially waterproof, dustproof, and rugged housing to limit and/or prevent the environment of the wellbore 354 from entering the electric motor 304. In an embodiment, the electric motor 304 may have low inertia characteristics and unique rotor designs compared to other induction motors since the electric motor 304 does not have the same high-operating-speed restrictions as typical induction motors. In such an embodiment, the VFD 300 may be configured to cause the power output therefrom to exhibit a frequency or frequencies of about 10 Hz to about 20 Hz, about 15 Hz to about 25 Hz, about 20 Hz to about 30 Hz, about 25 Hz to about 35 Hz, about 30 Hz to about 40 Hz, about 35 Hz to about 45 Hz, about 40 Hz to about 50 Hz, about 45 Hz to about 55 Hz, about 50 Hz to about 60 Hz, about 55 Hz to about 65 Hz, about 60 Hz to about 70 Hz, about 65 Hz to about 75 Hz, about 70 Hz to about 80 Hz, about 75 Hz to about 85 Hz, about 80 Hz to about 90 Hz, about 85 Hz to about 95 Hz, about 90 Hz to about 100 Hz, about 95 Hz to about 110 Hz, about 100 Hz to about 120 Hz, about 110 Hz to about 130 Hz, about 120 Hz to about 140 Hz, about 130 Hz to about 150 Hz, about 140 Hz to about 160 Hz, or greater than 150 Hz. The frequency (e.g., maximum and minimum frequency) of the power provided from the VFD 300 may be selected based on a number of factors. In an example, the frequency of the power output from the VFD 300 may be restricted by the mechanical limitations of the downhole ESP equipment. In an example, the frequency of the power outputted from the VFD 300 may be selected based on the head in feet delivered by the pump 352 or the desired number of barrels per day desired to be provided by the ESP system 350. In an example, the frequency of the power from the VFD 300 may be selected based on the desired minimum flow and/or maximum flow of the ESP system 350. In an example, the frequency of the power outputted from the VFD 300 may be selected based on at least one of the maximum or desired head capacity, the desired or maximum pump efficiency, or the desired brake horsepower of the electric motor 304. It is noted that varying the frequency of the power from the VFD 300 and the accompanying changes in the speed of the electric motor 304 allows greater flexibility in the ESP system 350.

In an embodiment, the VFD 300 is configured to supply or provide electrical power to the electric motor 304 exhibiting a voltage of about 25 volts (“V”) to about 750 V, such as about 25 V to about 75 V, about 50 V to about 100 V, about 75 V to about 125 V, about 100 V to about 150 V, about 125 V to about 175 V, about 150 V to about 200 V, about 175 V to about 250 V, about 200 V to about 300 V, about 250 V to about 350 V, about 300 V to about 400 V, about 350 V to about 450 V, about 400 V to about 500 V, about 450 V to about 550 V, about 500 V to about 600 V, about 550 V to about 650 V, about 600 V to about 700 V, or about 650 V to about 750 V. The voltage of the electrical power may be selected based on one or more factors. In an example, the voltage of the power from the VFD 300 may be selected at least partially based on the desired electrical power or torque outputted by the electric motor 304. In an example, the VFD 300 may vary the voltage of the power supplied therefrom.

As previously discussed, the ESP system 350 includes a pump 352. The pump 352 is mechanically connected to the electric motor 304 such that the electric motor 304 provides energy to the pump 352. For example, the ESP system 350 may include a shaft (not shown) or other mechanical connection extending from the electric motor 304 to the pump 352. For example, the electric motor 304 may rotate the shaft and the shaft may provide the rotational energy to the pump 352. In an embodiment, the pump 352 includes a multistage centrifugal pump or another suitable pump.

The pump 352 includes an intake 356 configured to receive well fluids from the wellbore 354. In an embodiment, as illustrated, the intake 356 may be separate from and in fluid communication with the pump 352. In an embodiment, the intake 356 forms part of the pump 352.

The ESP system 350 may include a seal section 358. The seal section 358 is configured to improve the operating life and performance of the ESP system 350 by isolating well fluids from one or more components of the ESP system 350. For example, the seal section 358 may be configured to at least one of protect the electric motor 304 from the well fluid, thereby keeping the oil of the electric motor 304 clean, providing pressure equalization between the electric motor 304 and the wellbore 354, carrying the thrust load of the pump 352, compensating motor oil volume during operation of the ESP system 350, or transferring torque from the electric motor 304 to at least one of the intake 356, a gas separator/handler (not shown), or the pump 352. As such, the seal section 358 may extend the useful life of the ESP system 350. The seal section 358 may be formed from a single piece, may be formed from a plurality of pieces (e.g., exhibits a modular design), or may have one or more components attached thereto.

The ESP system 350 may include one or more additional components. In an embodiment, as shown, the ESP system 350 may include a wellhead 360. The wellhead 360 may provide at least one of tubing support, a power cable to go from the surface to the wellbore 354, one or more valves, or one or more outlets through which the well fluids may be conducted. In an embodiment, the ESP system 350 may include one or more conduits 362. The conduits 362 may be configured to carry or transfer the well fluids therethrough. The conduits 362 may also provide a location for a power cable to extend such that electrical power may be provided to the electric motor 304. In an embodiment, the ESP system 350 may include one or more sensors 334. The one or more sensors 334 may be configured to detect one or more characteristics of the electric motor 304, the wellbore 354, the pump 352, or any other component of the ESP system 350. The one or more sensors 334 may include any of the sensors disclosed herein.

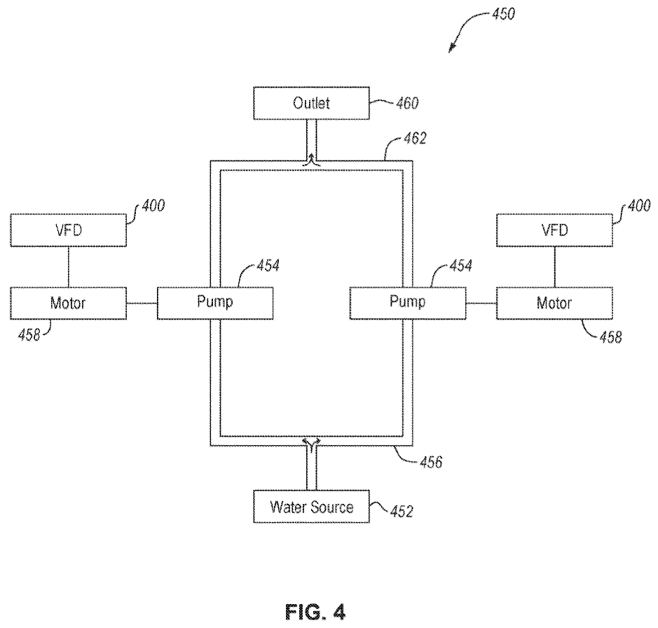

As previously discussed, the VFDs disclosed herein may be used in a water pump system. FIG. 4 is a schematic illustration of a water pump system 450, according to an embodiment. The water pump system 450 includes a water source 452. The water source 452 is in fluid communication with one or more pumps 454 via one or more first conduits 456. In an embodiment, as illustrated, the one or more pumps 454 include two pumps though, it is noted, the water pump system 450 may include a single pump or three or more pumps. Each of the pumps 454 is attached to or integrally formed with a motor 458 that provides power (e.g., rotational force) to the pumps 454. The water pump system 450 includes at least one VFD 400 that at least partially controls the operation of the motor(s) 458. Except as otherwise disclosed herein, the VFD 400 may be the same or substantially similar to any of the VFDs disclosed herein. In the illustrated embodiment, each of the motors 458 is controlled their own VFD 400 though, it is noted, a single VFD may control two or more motors 458. The pumps 454 may be in fluid communication to an outlet 460 via one or more second conduits 462. In other words, the pumps 454 may output the water to the second conduits 462 and the second conduits 462 may provide the water to the outlet 460. It is noted that the water pump system 450 may include other components, such as sensors, filters, an electrical power source, etc.

The water pump system 450 is configured to provide maximum flow of the water to the outlet 460 at optimal efficiency. The rate at which the motors 458 provide power to the pumps 454 may vary over time based on need. For example, the motors 458 may increase or decrease the power provided to the pumps 454. The VFDs 400 control the motors 458 to prevent damage to the motors 458 while increasing or decreasing power provided to the pumps 454. The VFDs 400 also prevent damage to the motors 458 by preventing the motors 458 from operating continuously at maximum power. However, as previously discussed, the VFDs 400 may have excess computing power, access to excess electrical power, or otherwise be able to execute the high-power consuming modules discussed above.

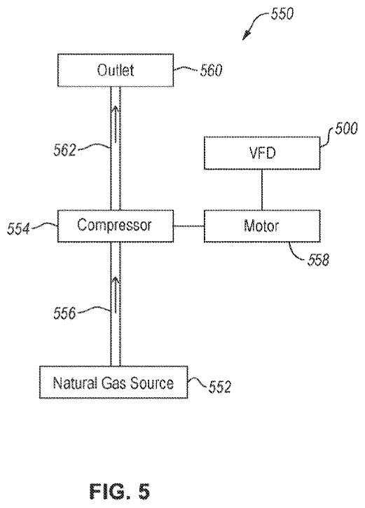

As previously discussed, the VFDs disclosed herein may be used in a natural gas compressor system. FIG. 5 is a schematic illustration of a natural gas compressor system 550, according to an embodiment. The natural gas compressor system 550 includes a natural gas source 552. The natural gas source 552 is in fluid communication with at least one compressor 554 via one or more first conduits 556. In the illustrated embodiment, the at least one compressor 554 includes a single compressor though, it is noted, the natural gas compressor system 550 may include a plurality of compressors. Each compressor 554 is attached to or integrally formed with a motor 558 that provides power to the compressor 554. The motor 558 is at least partially controlled by a VFD 500. Except as otherwise disclosed herein, the VFD 500 may be the same or substantially similar to any of the VFDs disclosed herein. The compressor 554 may be in fluid communication to an outlet 560 via one or more second conduits 562. It is noted that the natural gas compressor system 550 may include other components, such as sensors, filters, an electrical power source, tanks, air inlets, coolers, separators, etc.

The natural gas compressor system 550 is configured to provide maximum flow or a desired pressure of the natural gas at the outlet 560 at optimal efficiency. Similar to the water pump system 450, the rate at which the motors 558 of the natural gas compressor system provide power to the compressors 554 may vary over time based on need. The VFD 500 control the motors 558 to prevent damaging the motors 558 while increasing or decreasing power to the compressors 554. However, as previously discussed, the VFD 500 may have excess computing power, access to excess electrical power, or otherwise be able to execute the high-power consuming modules discussed above.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, or ±2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

1. A variable frequency drive, comprising:
a housing;
at least one computer processor disposed in the housing;
non-transitory memory in communication with the at least one computer processor, the non-transitory memory disposed in the housing;
at least one transceiver disposed in the housing;
a power input in or on the housing;
a power output in or on the housing;
at least one high-power consuming module configured to be executed on at least one of the at least one computer processor or on at least one other computer processor, wherein the at least one other computer processor is distinct from the at least one computer processor; and
an energy-efficiency module configured to be executed on at least one of the at least one computer processor or on the at least one other computer processor that is distinct from the at least one computer processor, the energy-efficiency module configured to:
determine whether the at least one high-power consuming module will or will not be efficiently executed on the at least one computer processor or on the at least one other computer processor; and
permit the at least one high-power consuming module to be executed on the at least one computer processor or on the at least one computer processor when the energy-efficiency module determines that doing so is desirable; or
prevent the at least one high-power consuming module from being executed on the at least one computer processor or on the at least one computer processor when the energy-efficiency module determines that doing so is not desirable.

2. The variable frequency drive of claim 1, wherein the at least one high-power consuming module is configured to be executed on the at least one computer processor.

3. The variable frequency drive of claim 1, further comprising a high-power consuming component disposed in the housing, the high-power consuming component include at least one component computer processor that is distinct from the at least one computer processor and component non-transitory memory that is distinct from the non-transitory memory; and
wherein the at least one high-power consuming module is configured to be executed on at least the component computer processor.

4. The variable frequency drive of claim 1, wherein the at least one high-power consuming module includes at least one cryptocurrency module.

5. The variable frequency drive of claim 1, wherein the energy-efficiency module determines whether the at least one high-power consuming module will or will not be efficiently executed on the at least one computer processor when the energy-efficiency module determines that there is or is not sufficient excess electrical power available in a region, respectively.

6. The variable frequency drive of claim 1, further comprising an input converter connected to the power input, an output converter connected to the power output, a DC bus connected to and between the input converter and the output converter, and a power control module configured to control at least one of the input converter, the output converter, or the DC bus.

7. The variable frequency drive of claim 1, further comprising a cost module configured to be executed on at least one of the at least one computer processor or on the at least one other computer processor that is distinct from the at least one computer processor, the cost module configured to determine or at least estimate at least one of a cost of executing the high-power consuming module or a value obtained executing the high-power consuming module.

8. An electrical submersible pumping system, comprising:
a power source;
the variable frequency drive of claim 1, the power input connected to the power source, the variable frequency drive configured to be disposed on a surface;
a pump configured to be disposed in a wellbore;
an electric motor connected to the electrical power output of the variable frequency drive, the electric motor configured to be disposed in the wellbore, the electric motor connected to and configured to provided power to the pump; and
a seal section configured to be disposed in the wellbore.

9. A water pump system, comprising:
one or more pumps in fluid communication with a water source and an outlet;
one or more motors connected to or integrally formed with the one or more pumps; and
the variable frequency drive of claim 1, the variable frequency drive configured to at least partially control the one or more motors.

10. A natural gas compressor system, comprising:
one or more compressors in fluid communication with a natural gas source and an outlet;
one or more motors connected to or integrally formed with the one or more compressors; and
the variable frequency drive of claim 1, the variable frequency drive configured to at least partially control the one or more motors.

11. A computer-based system, comprising:
at least one computer processor;
non-transitory memory in communication with the at least one computer processor;
at least one transceiver;
at least one high-power consuming module executing on the at least one computer processor; and
an energy-efficiency module configured to:
determine whether the at least one high-power consuming module will or will not be executed on the at least one computer processor by determining whether there is or is not, respectively, sufficient excess electrical power provided at least one of on-site or in a region that will be wasted if not used; and
selectively permit the at least one high-power consuming module to be executed.

12. The computer-based system of claim 11, wherein the at least one high-power consuming module includes at least one cryptocurrency module.

13. The computer-based system of claim 11, wherein the energy-efficiency module determines whether the at least one high-power consuming module will or will not be efficiently executed on the at least one computer processor when the energy-efficiency module determines that there is or is not, respectively, sufficient excess electrical power provided on-site that will be waste if not used.

14. The computer-based system of claim 11, wherein the energy-efficiency module determines whether the at least one high-power consuming module will or will not be efficiently executed on the at least one computer processor when the energy-efficiency module determines that there is or is not, respectively, sufficient excess electrical power available in a region that will be waste if not used.

15. The computer-based system of claim 11, wherein the energy-efficiency module determines whether the at least one high-power consuming module will or will not be efficiently executed on the at least one computer processor when the energy-efficiency module determines that a current price of electrical power is below or above a threshold value, respectively;
wherein the transceiver is configured to receive the current price of electrical power.

16. The computer-based system of claim 11, wherein the energy-efficiency module determines whether the at least one high-power consuming module will or will not be efficiently executed on the at least one computer processor when the energy-efficiency module determines whether the at least one computer processor does or does not have sufficient excess computing power available to execute the high-power consuming module, respectively.

17. The computer-based system of claim 11, wherein the energy-efficiency module determines whether the at least one high-power consuming module will or will not be efficiently executed on the at least one computer processor when the energy-efficiency module determine that there is or is not sufficient excess computing power available on one or more computer-based systems communicably coupled to the computer-based system via the transceiver to execute the high-power consuming module on the at least one computer processor and the one or more computer-based systems, respectively.

18. The computer-based system of claim 11, wherein, when the at least one high-power consuming module includes at least one cryptocurrency module, the energy-efficiency module determines whether the at least one high-power consuming module will or will not be efficiently executed on the at least one computer processor when the energy-efficiency module determines that a current price of a cryptocurrency is above or below a threshold value, respectively;
wherein the transceiver is configured to receive the current price of the cryptocurrency.

19. The computer-based system of claim 11, wherein the computer-based system is a variable frequency drive.

20. The computer-based system of claim 19, further comprising an input converter connected to a power input, an output converter connected to a power output, a DC bus connected to and between the input converter and the output converter, and a power control module configured to control at least one of the input converter, the output converter, or the DC bus.

21. A method of using a computer-based system, comprising:
with an energy-efficiency module executed on at least one computer processor:
determining whether at least one high-power consuming module will or will not be efficiently executed on the at least one computer processor by determining whether there is or is not, respectively, sufficient excess electrical power provided at least one of on-site or in a region that will be wasted if not used; and
permitting the at least one high-power consuming module to be executed on the at least one computer processor when the energy-efficiency module determines that operating the at least one high-power consuming module is advantageous; and
preventing the at least one high-power consuming module from being executed on the at least one computer processor when the energy-efficiency module determines that operating the at least one high-power consuming module processor is not advantageous;
wherein the computer-based system includes memory in communication with the at least one computer processor and at least one transceiver.
